(19) United States
(12) Patent Application Publication
(10) Pub. No.: US 2024/0263834 A1
(43) Pub. Date: Aug. 8, 2024

(54) CONDUIT AND JUNCTION BOX ASSEMBLIES AND METHODS FOR WATER HEATERS

(71) Applicant: Rheem Manufacturing Company, Atlanta, GA (US)

(72) Inventors: Jeremy Allen Peters, Coosada, AL (US); Martin John Fabian, Dadeville, AL (US); Madhuresh Bhandari, Montgomery, AL (US); Timothy David Scott, Tallassee, AL (US); Robert Johnson, Pike Road, AL (US)

(21) Appl. No.: 18/418,758

(22) Filed: Jan. 22, 2024

Related U.S. Application Data
(60) Provisional application No. 63/483,289, filed on Feb. 5, 2023.

(51) Int. Cl. F24H 1/18; H02G 3/08; H02G 3/14

(52) U.S. Cl. CPC F24H 1/182; H02G 3/081; H02G 3/14

(57) ABSTRACT

A junction box is provided for use with a water heater, a conduit, and a wire, the water heater having a water tank, a jacket separated from and concentrically surrounding the water tank, a coupling on the water tank, an electrical device associated with the coupling, and insulation disposed between the water tank and the jacket, the conduit being configured to be disposed between the water tank and the jacket, the wire being configured to be disposed within the conduit and being configured to be connected to the electrical device, the jacket having a jacket opening at the coupling.

### CROSS-REFERENCE TO RELATED APPLICATIONS

This application claims priority to and the benefit of U.S. provisional application No. 63/483,289, filed Feb. 5, 2023, which is hereby incorporated by reference herein in its entirety.

### FIELD

This disclosure relates generally to water heaters and more particularly to water heaters having conduit and junction box assemblies for wire and line management.

### BACKGROUND

FIG. 1A depicts a cross-sectional view of a prior art water heater 100 at a time t₀. The water heater 100 includes a water tank 102, a jacket 104, a control system 106, an electrical device 108, an electrical device 110, a control line 112, a control line 114, and a layer of hardened insulating foam 116.

During manufacture, any electrical devices, such as heating elements, sensors, etc., are mounted to the water tank 102. Control lines are then connected between the electrical devices and the control system to control the electrical devices. In order to service and/or replace either the control system or any of the electrical devices, accessibility is a factor to consider. Therefore, as shown in this case, the control system 106 is disposed on a top 118 surface of the jacket 104. Likewise, each of the electrical devices 108 and 110 are mounted to the water tank 102, but are accessible through the jacket 104 via access ports 120 and 122, respectively.

The control line 112 enables the control system 106 to communicate with the electrical device 108, whereas the control line 114 enables the control system 106 to communicate with the electrical device 110. In some instances, the control lines 112 and 114 are disposed between the water tank 102 and the jacket 104.

In some instances, to insulate the water tank 102, a liquid foam is sprayed between the jacket 104 and the water tank 102 during manufacture of the water heater 100. The liquid foam fills the space between the jacket 104 and the water tank 102, including surrounding the control lines 112 and 114, and hardens to form the layer of hardened insulating foam 116. The layer of hardened insulating foam 116 insulates the water tank 102 to reduce parasitic heat conduction from the water tank 102 to the air outside of the jacket 104.

FIG. 1B illustrates a cross-sectional view of the prior art water heater 100 at a time t₁. Here, the control line 114 has been severed. This may occur for many known reasons, such as jarring movement of the water heater 100 during delivery or installation or simply corrosion over time. In any event, a new control line must be connected between the control system and the electrical device 110. However, because the space between the water tank 102 and the jacket 104 is filled with the layer of hardened insulating foam 116, a new control line cannot be threaded from the electrical device 110 to the control system 106 within the layer of hardened insulating foam 116.

FIG. 1C illustrates a cross-sectional view of the prior art water heater of FIG. 1A at a time t₂. Because a new control line cannot be threaded from the electrical device 110 to the control system 106 within the layer of hardened insulating foam 116, in prior art systems, a new control line must be installed on the exterior of the jacket 104. As shown in FIG. 1C, a new control line 118 is connected between the electrical device 110 and the control system 106. The exposed new control line 118 may be considered unsightly. In some instances, to prevent a passerby from accidentally pulling out the newly installed control line 118, the new control line 118 is covered with a wire sheathing 120 that is typically adhered to the outside of the jacket 104. A customer typically finds wire sheathing 120 to be expensive, problematic, and look unfinished.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1A illustrates a cross-sectional view of a prior art water heater at a time t₀.

FIG. 1B illustrates a cross-sectional view of the prior art water heater of FIG. 1A at a time t₁.

FIG. 1C illustrates a cross-sectional view of the prior art water heater of FIG. 1A at a time t₂.

FIG. 2A illustrates a front view of a system of junction boxes and conduits in accordance with one or more embodiments of the present disclosure.

FIG. 2B illustrates a cross-sectional view of the system of FIG. 2A in accordance with one or more embodiments of the present disclosure.

FIG. 3A illustrates a front view of a junction box in accordance with one or more embodiments of the present disclosure.

FIG. 3B illustrates a top cross-sectional view of the junction box of FIG. 3A as cut along an axis B-B in accordance with one or more embodiments of the present disclosure.

FIG. 3C illustrates a mounting opening of the junction box of FIG. 3A in accordance with one or more embodiments of the present disclosure.

FIG. 4A illustrates a front view of another junction box in accordance with one or more embodiments of the present disclosure.

FIG. 4B illustrates a top cross-sectional view of the junction box of FIG. 4A as cut along an axis C-C in accordance with one or more embodiments of the present disclosure.

FIG. 5A illustrates a perspective view of a cavity cover for use with a junction box in accordance with one or more embodiments of the present disclosure.

FIG. 5B illustrates a top view of the cavity cover of FIG. 5A in accordance with one or more embodiments of the present disclosure.

FIG. 5C illustrates a front view of the cavity cover of FIG. 5A in accordance with one or more embodiments of the present disclosure.

FIG. 5D illustrates a cross-sectional view of the cavity cover of FIG. 5C along a line D-D in accordance with one or more embodiments of the present disclosure.

FIG. 5E illustrates a cross-sectional view of a portion of the cavity cover of FIG. 5C along a line E-E in accordance with one or more embodiments of the present disclosure.

FIG. 5F illustrates a bottom view of the cavity cover of FIG. 5C in accordance with one or more embodiments of the present disclosure.

FIG. 6 illustrates a method of making a water heater in accordance with one or more embodiments of the present disclosure.

### DETAILED DESCRIPTION

This disclosure relates generally to water heaters having electrical devices. In some instances, the electrical devices are wired to a control system and/or other electrical devices about the water heaters. In accordance with one embodiment, a system of one or more conduits and junction boxes are used to rout wires between a control system and/or electrical devices (or other electrical devices) on the outside of a water tank. The conduits may be at least partially disposed in a space between the water tank and the surrounding jacket. Insulating foam may be deposited in the space between the water tank and the surrounding jacket (but not within the conduits and junction boxes disposed between the water tank and the surrounding jacket. In this manner, the conduits may enable the wires to be replaced in the event of a disconnection or malfunction.

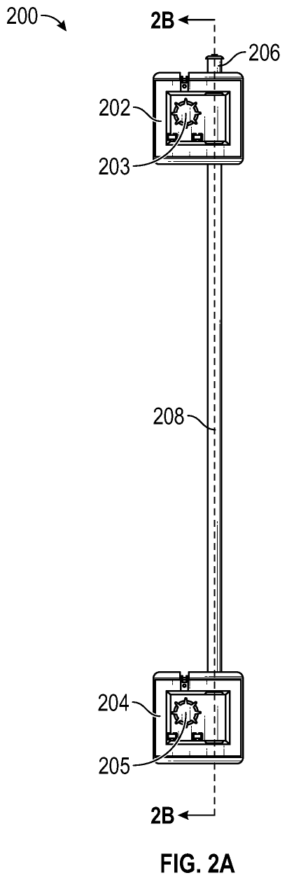

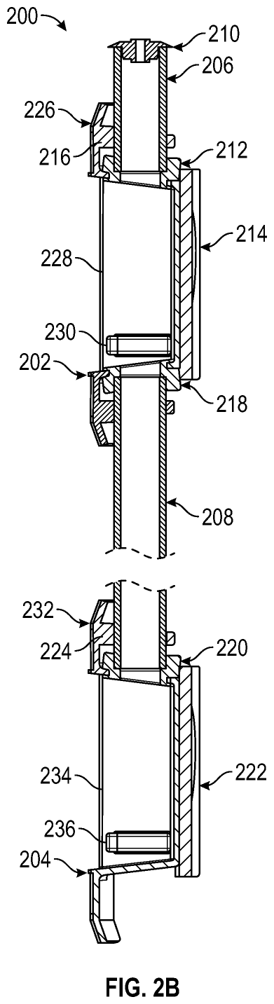

Turning now to the drawings, FIG. 2A illustrates a front view of a system 200 of one or more junction boxes and conduits in accordance with one or more embodiments of the present disclosure. In some instances, the system 200 includes a first junction box 202, a second junction box 204, a first conduit 206, and a second conduit 208. The system 200 may include any number of junction boxes and conduits. In some instances, the water tank (not shown) includes a coupling 203 and a coupling 205. In certain embodiments, the coupling 203 has an electrical device associated therewith, and the coupling 205 has an electrical device associated therewith.

The electrical devices may be any known type of heating element or sensor that requires electricity to operate. For example, the electrical devices may include one or more temperature sensors, fluid level sensors, pressure sensors, and/or heating elements. Any suitable electronic devices may be used herein.

In certain embodiments, the first conduit 206 is disposed about the first junction box 202 to enable wiring to pass from the junction box 202, through the first conduit 206, and to a control system (not shown) on top of the water heater or at any other suitable position. The wiring may therefore connect the electrical device associated with the coupling 203 to the control system via the conduit 206.

In some instances, the second conduit 208 is disposed between the first junction box 202 and the second junction box 204 to enable wiring to pass from the second junction box 204, through the second conduit 208, through the first junction box 202, through the first conduit 206, and to a control system (not shown) of the water heater, which in some instances may be disposed on top of the water heater. The control system may be located anywhere about the water heater. The wiring may therefore connect the electrical device associated with the coupling 205 to the control system via the first conduit 206, the first junction box 202, the second conduit 208, and the second junction box 204.

Any number of conduits may extend between the first junction box 202 and the second junction box 204. In addition, any number of junction boxes may be disposed about the water heater at any number of locations about the water tank, and any number of conduits may connect the various junction boxes. That is, any number of conduits may be connected to each of the junction boxes. More so, the conduits may traverse the water heater in any suitable direction and may include a corresponding curvature to the water tank in order to nest between the water tank and the surrounding jacket. In some instances, only a single junction box and one or more conduits may be used.

FIG. 2B illustrates a cross-sectional view of the system of FIG. 2A. The system 200 further includes a temporary stopper 210, a first grommet 212, a first junction box back gasket 214, a first junction box front gasket 216, a second grommet 218, a third grommet 220, a second junction box back gasket 222, and a second junction box front gasket 224. In certain embodiments, the first junction box 202 includes a front face 226 and a cavity section 228, which in this example includes a retaining latch 230. The second junction box 204 includes a front face 232 and a cavity section 234, which in this example includes a retaining latch 236.

The temporary stopper 210 is configured to be removably disposed about and/or within a top end of the first conduit 206. When in place, the temporary stopper 210 is configured to prevent water or other material from entering into the first conduit 206 during manufacture, insulation, and/or use of the water heater.

The first grommet 212 may be disposed about a bottom end of the first conduit 206 at a connection with the first junction box 202. In some instances, the first grommet 212 is configured to prevent foam from entering into the first junction box 202 where the conduit 206 enters the first junction box 202. The first junction box back gasket 214 is configured to be between the back of the first junction box 202 and the wall of the water tank (not shown). The first junction box front gasket 216 may be disposed between a front face 226 of the first junction box 202 and the outer surface of the jacket (not shown). In some instances, the second grommet 218 is disposed at a connection between the first junction box 202 and the second conduit 208. The second grommet 218 is configured to prevent foam from entering into the first junction box 202 where the second conduit 208 enters the first junction box 202.

The third grommet 220 may be disposed at a connection between the second conduit 208 and the second junction box 204. In some instances, the third grommet 220 is configured to prevent foam from entering into the second junction box 204 where the second conduit 208 enters the second junction box 204. The second junction box back gasket 222 is configured to be between the back of the second junction box 204 and the wall of the water tank (not shown). The second junction box front gasket 224 may be disposed between a front face 232 of the second junction box 204 and the outer surface of the jacket (not shown). In some instances, the first junction box 202 includes the front face 226 and the cavity section 228, which in this example includes a retaining latch 230. Similarly, the second junction box 204 may include the front face 232 and the cavity section 234, which in this example includes a retaining latch 236.

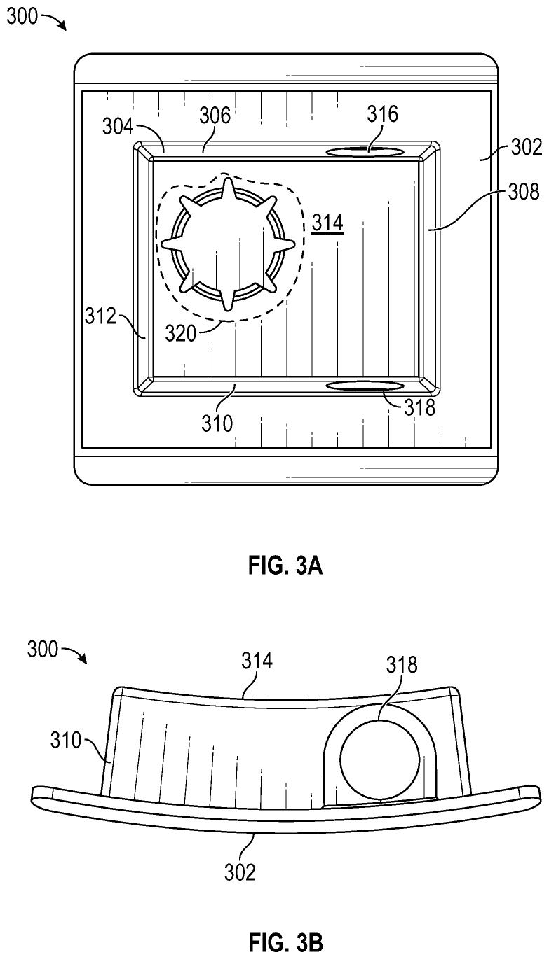

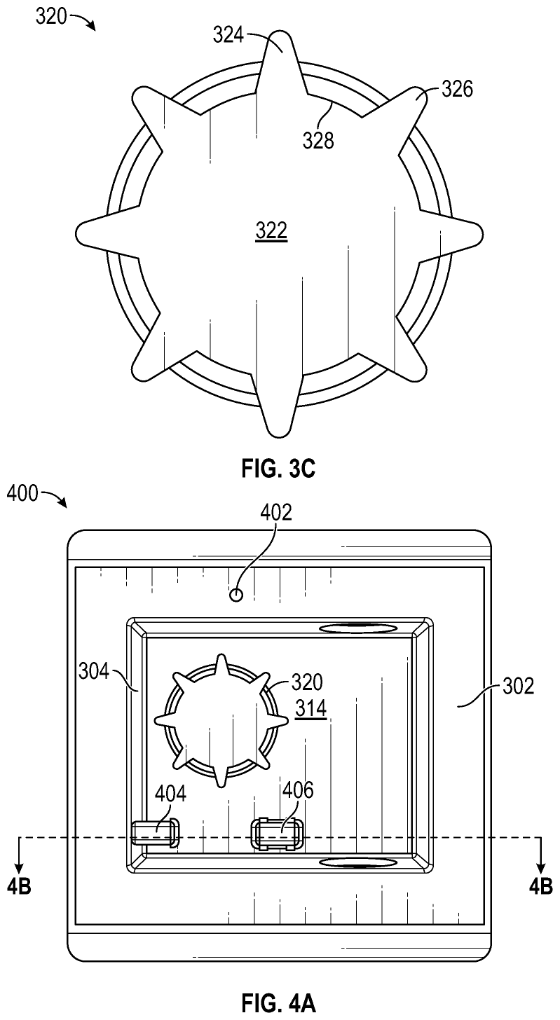

FIG. 3A illustrates a front view of a junction box 300 in accordance with one or more embodiments of the present disclosure. The junction box 300 may be the same as or similar to the first junction box 202 and/or the second junction box 204. As depicted in FIG. 3A, the junction box 300 may include a curved front face 302 and a cavity section 304. In some instances, the cavity section 304 includes an upper surface 306, a side surface 308, a lower surface 310, a side surface 312, and a back surface 314.

The upper surface 306 may include a hole 316 configured to receive a conduit (e.g., the first conduit 206 or the second conduit 208). The lower surface 310 may include a hole 318 configured to receive a conduit (e.g., the second conduit 208). The back surface 314 may include a mounting opening 320 configured to mount onto a corresponding coupling on a water tank.

FIG. 3B illustrates a top cross-sectional view of the junction box 300 as cut along an axis B-B in FIG. 3A. The curved front face 302 may include a front face curvature configured to match a curvature of the jacket. In this example, the curved front face 302 has a curvature radius of about 16.069 inches. Any suitable curvature radius may be used herein. The back surface 314 may include a cavity curvature configured to match a curvature of the water tank. In this example, the back surface 314 has a curvature radius of about 14.100 inches. Any suitable curvature radius may be used herein. In some instances, the hole 318 is configured to receive a conduit (e.g., the first conduit 206 or the second conduit 208). In this example, the hole 318 is circular and has a diameter of about 1.063 inches. The hole may be any suitable diameter. In some instances, the inner diameter of the hole 318 may substantially correspond to an outer diameter of a conduit.

FIG. 3C illustrates a detailed view of the mounting opening 320 of the junction box 300. The mounting opening 320 may include a generally circular opening 322 with a plurality of cutouts. In this example, the mounting opening 320 includes eight cutouts, a sample of which are labeled as cutouts 324 and 326, wherein each of the cutouts is separated from its respective neighbors by about 45°. Any suitable angle may be used herein. In this example, the generally circular opening 322 may include a radius of about 1.503 inches. Any suitable radius may be used herein.

In certain embodiments, neighboring cutouts may produce flexible tab portions. For example, a tab portion 328 may be formed from the cutout 324 and the cutout 326. The plurality of tabs may be configured to flex inward (in a direction normal and out of the figure) so as to permit a ridge on a coupling of the water tank to pass through. Once the junction box 300 is pressed firmly against the side of the water tank, the ridge of the coupling may pass through the mounting opening 320, and the plurality of tabs may snap back into place, thus locking behind the ridge on the coupling. This may retain the junction box 300 in position on the side of the water tank.

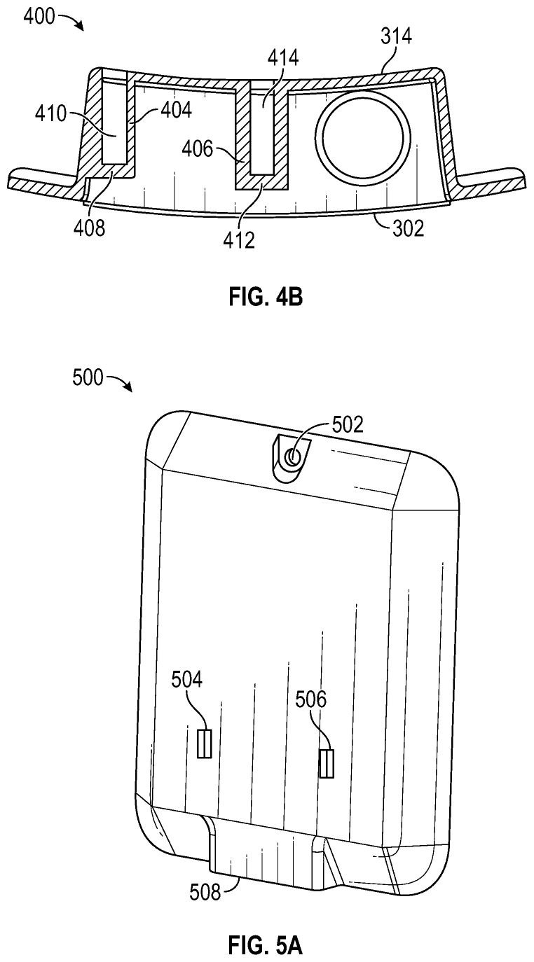

FIG. 4A illustrates a front view of a junction box 400 in accordance with one or more embodiments of the present disclosure. The junction box 400 may be the same as or similar to the first junction box 202, the second junction box 204, and/or the junction box 300. In this embodiment, the junction box 400 includes all the elements of the junction box 300 discussed above with reference to FIG. 3A. Returning to FIG. 4A, the junction box 400 additionally may include fastening mechanisms to enable a cavity cover to be detachably fastened to the junction box 400 so as to cover the cavity section of the junction box 400. Non-limiting examples of fastening mechanisms include screw holes about the curved front face, latches disposed in the cavity section so as to receive respective hooks, and/or combinations thereof. Any suitable attachment mechanism may be used.

In the junction box 400, the curved front face 302 may include a screw hole 402, whereas the cavity section 304 may include a first latch 404 and a second latch 406 disposed on the back surface 314.

FIG. 4B illustrates a top cross-sectional view of the junction box 400 as cut along an axis C-C in FIG. 4A. The first latch 404 may include a latch arm 408 disposed in front of a space 410, whereas the second latch 406 may include a latch arm 412 disposed in front of a space 412. In operation, a hook from a cavity cover, as will be described in greater detail below, may hook over the latch arm 408 and rest in the space 410, whereas another hook from the cavity cover may hook over the latch arm 412 and rest in the space 414. This hook and latch configuration may keep the cavity cover detachably fastened on the junction box 400 so as to cover the cavity section 304.

In this example, the space 410 and the space 414 have a width of about 0.313 inches. The back edge of the latch arm 408 is about 0.662 inches from the front surface of the curved front face 302. The back edge of the latch arm 412 is about 0.508 inches from the front surface of the curved front face 302. In some instances, the distances of the latch arms differ as a result of the curvature of the curved front face 302. The space 410 is separated from the space 414 by a distance of about 1.612 inches. Any suitable distance may be used with regard to the aforementioned dimensions.

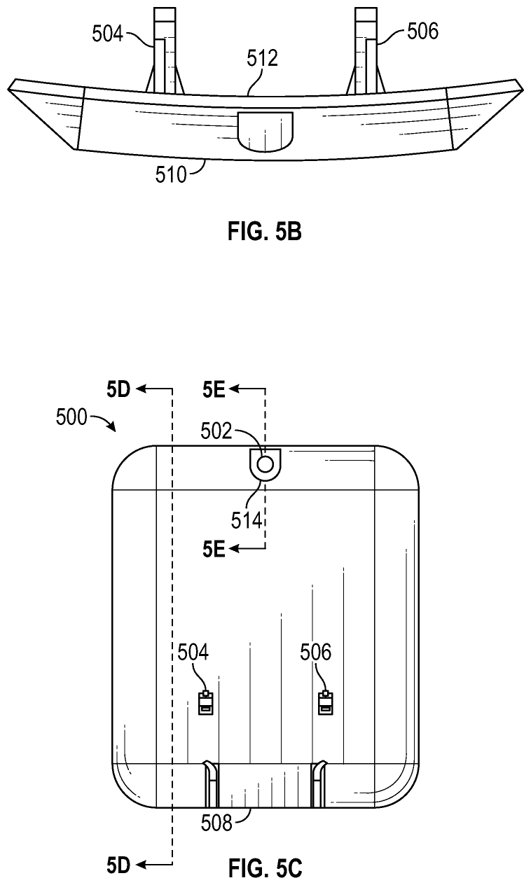

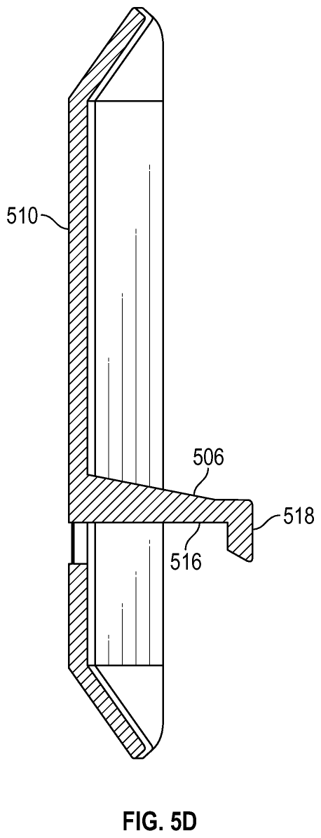

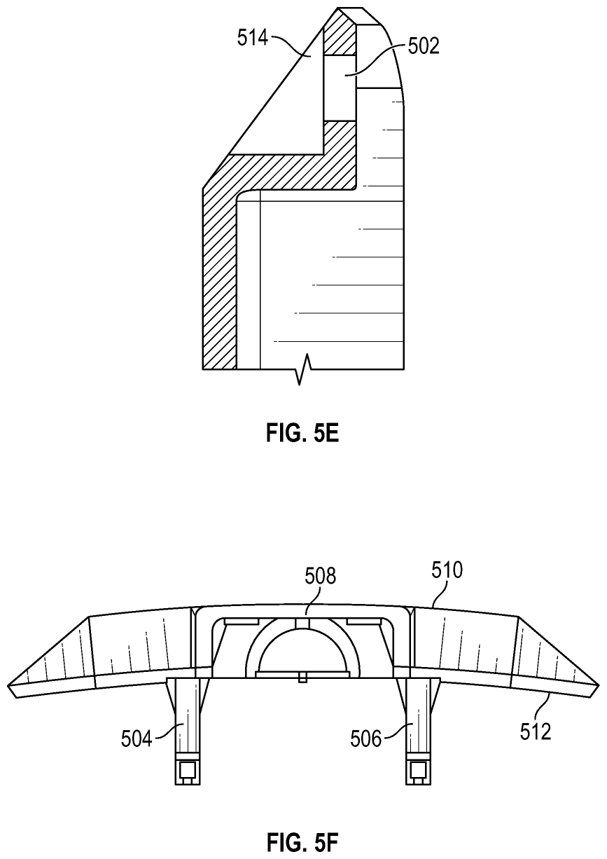

FIG. 5A illustrates a perspective view of a cavity cover 500 for use with a junction box in accordance with one or more embodiments of the present disclosure. In certain embodiments, the cavity cover 500 includes a screw hole 502, a first hook 504, a second hook 506, and a handle portion 508.

FIG. 5B illustrates a top view of the cavity cover 500. In some instances, the cavity cover 500 has a curved front surface 510 and a curved rear surface 512. The curved rear surface 512 may include a curvature that is configured to correspond to the curvature of the front face of a junction box as described here. In this example, the front surface 510 has a curvature radius of about 16.177 inches, whereas the rear surface 512 has a curvature radius of about 15.589 inches. Any suitable curvature radius may be used herein. Each of the first hook 504 and the second hook 506 may extend to a distance of about 1.446 inches from the front surface 510. Any suitable distance may be used herein.

FIG. 5C illustrates a front view of the cavity cover 500. In this example, the cavity cover 500 has a width of about 4.898 inches, the first hook 504 and the second hook 506 are separated from the screw hole 502 by longitudinal distance of about 3.663 inches, and the screw hole 502 is disposed in a recess 514, wherein the recess 514 has a diameter of about 0.480 inches, and the screw hole 502 has a diameter of about 0.250 inches. Any suitable dimensions may be used herein.

FIG. 5D illustrates a cross-sectional view of the cavity cover 500 along a line D-D in FIG. 5C. In this example, the cavity cover 500 has a thickness of about 0.689 inches. Any suitable thickness may be used herein. Each of the first hook 504 and the second hook 506 (although only the hook 506 is illustrated in FIG. 5D) may include an arm 516 and a hooking portion 518. In this example, the arm 516 has a length of about 1.100 inches from the rear of the front surface 510. The arm 516 may be any suitable length. The hooking portion 518 of each of the first hook 504 and the second hook 506 may be configured to engage the respective space 410 and the space 414 when the cavity cover 500 is attached to the junction box.

FIG. 5E illustrates a detailed cross-sectional view of a portion of the cavity cover 500 along a line E-E in FIG. 5C. In this example, the distance from the edge of the recess 514 to the center of the screw hole 502 is about 0.250 inches. The screw hole 502 may be located at any suitable location on the cavity cover 500.

FIG. 5F illustrates a bottom view of the cavity cover 500. In this example, the distance from an inner surface of the handle portion 508 and the rear surface 512 is about 0.440 inches, the center-to-center distance between the first hook 504 and the second hook 506 is about 1.927 inches, the width of the end of each of the first hook 504 and the second hook 506 is about 0.188 inches, and the distance between the bases of the first hook 504 and the second hook 506 is about 1.500 inches. The aforementioned dimension may vary to accommodate different sized junction boxes and covers.

In operation, the cavity cover may be disposed about the junction box so as to partially or fully cover the cavity section of the junction box. As mentioned above, the cavity cover may be detachably fastened to the junction box by one or more mechanical attachment mechanisms, such as by screws, hooks, and/or combinations thereof. Any suitable attachment mechanisms may be used herein, including magnetic attachments, snap fit attachments, straps, or the like. In the examples discussed above with reference to FIGS. 4A-5F, a single screw is used in conjunction with two hooks/latches.

It should be noted that the first and second latches 404 and 406 as discussed above with reference to FIG. 4A are not centered within the cavity section 304, whereas the hooks 504 and 506 are centered on the cavity cover 500. These differing configurations are provided merely to illustrate that a hook/latch combination may be disposed anywhere in the system. The only condition being that a hook align with a latch such that the hooking portion of the hook can hook onto the corresponding latch arm of the latch. In some instances, the hook and latch may be omitted, and the cavity cover may be attached to the junction box via other means, such as one or more screws or the like.

Any number of screws may be used to screw the cavity cover to the junction box. In the examples discussed above with reference to FIGS. 4A-5F, while a single screw is used, any number of screws may be used. For example, a number of corresponding screw holes may be located in the cavity cover and junction box to receive respective screws therein for securing the cavity cover to the junction box. In such instances, the hooks/latches may be omitted. That is, in some instances, the screws may be the only mechanical attachment mechanism for securing the cavity cover to the junction box.

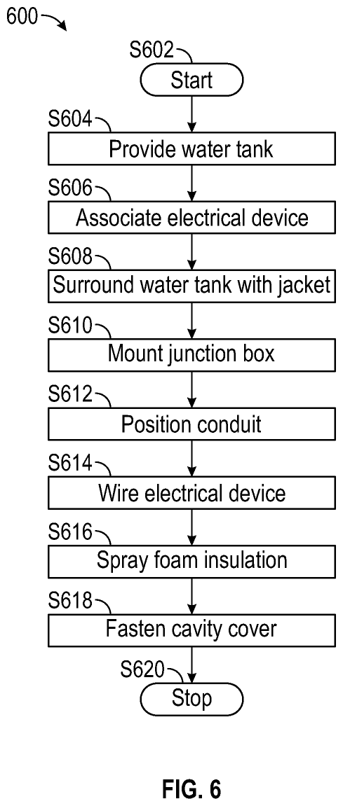

FIG. 6 illustrates a method 600 of making and/or using a water heater in accordance with one or more embodiments of the present disclosure. The method 600 starts (S602) and a water tank is provided (S604). As mentioned above, the water tank may include a plurality of electrical devices thereon, such as, among other things, sensors or heating elements. Any suitable electronic devices may be disposed about the water tank. Each of these electrical devices may be associated with (e.g., mounted on) a coupling that extends radially from the surface of the wall of the water tank. Each coupling may include a circular ridge that may be gripped by flexible tab portions as discussed above with reference to FIG. 3C.

Returning to FIG. 6, after the water tank is provided (S604), an electrical device may be associated with the water tank (S606). For example, as discussed above, for each coupling provided on the water tank, an electrical device may be mounted thereon. In some instances, a coupling may be used for a temperature sensor. In other instances, a coupling may be used for a water level sensor. In yet other instances, a coupling may be used for a heating element or a pressure sensor. Any device may be attached via the coupling.

After the electrical device is associated with the water tank (S606), the water tank may be surrounded by a jacket (S608). For example, by known methods, a jacket may be formed around the water tank. However, in accordance with one or more embodiments of the present disclosure, for every coupling on the water tank, a jacket opening may be provided. In some instances, the jacket openings may be cut into the jacket prior to forming around the water tank. In other instances, the jacket openings are cut into the jacket after forming the jacket around the water tank. The jacket openings, as will be described in greater detail below, may enable a junction box to be fixed onto the jacket such that a cavity section of the junction box rests in the jacket opening so as to press against the wall of the water tank.

After the water tank is surrounded by a jacket (S608), a junction box may be mounted (S610). For example, as shown in FIG. 4, the junction box 400 may be disposed such that the mounting hole 320 aligns with a coupling having an electrical device associated therewith. The junction box 400 may then be pressed against the water tank such that the tabs formed between cutout portions of the mounting hole 320, as shown in FIG. 3C, enable the ridge on the coupling to pass and lock the junction box 400 against the side of the water tank.

As shown in FIG. 2B, when the cavity section 228 of the junction box slides into the jacket opening, the rear surface of the junction box 202 may press the first junction box back gasket 214 against the wall of the water tank (not shown).

In certain embodiments, the purpose of the first junction box back gasket 214 is to provide some thermal insulation between the water tank and the junction box 202. For each jacket opening, wherein a junction box will reside, there will not be any insulating foam. As such, these surface areas may be prone to conduct thermal radiation at a greater rate than those covered by the insulating foam. To reduce this thermal radiation conduction (e.g., leaking of heat to the ambient air around the water heater) a gasket, such as the first junction box back gasket 214, is added behind each junction box. In some instances, these gaskets may have a greater thermal resistance than the insulating foam. Any suitable insulating material may be used for the gasket.

Returning to FIG. 6, after a junction box is mounted (S610), a conduit may be positioned about the water tank (S612). For example as shown in FIGS. 2A-B, the first conduit 206 is positioned so as to enable wiring to pass from a control system (not shown) on top of the water heater to the coupling within the first junction box 202, and the second conduit 208 is positioned so as to enable wiring to pass from the control system, through the first conduit 206, through the first junction box 202, through the second conduit 208, and into the second junction box 204.

Returning to FIG. 6, after a conduit is disposed (S612) about the water tank, the electrical device is wired (S614). For example, as shown in FIG. 2A, wire may be snaked through the first conduit 206 to connect an electrical device associated with the coupling 203 to the control system (not shown). Further, wire may be snaked through the first conduit 206, through the first junction box 202, and through the second conduit 208 to connect an electrical device associated with the coupling 205 to the control system (not shown).

For example, as shown in FIG. 3A, a wire may be fed through the junction box 300 by passing through the hole 316, through the cavity section 304, and out through the hole 318 to continue through another conduit if present.

It should be noted that while the example junction box 300 includes only two holes (i.e., the hole 316 and the hole 318), which are aligned on a single axis, any number of holes may be implemented. In particular, any of the upper surface 306, the side surface 308, the lower surface 310, and the side surface 312 may have one or more holes configured to receive a conduit. In this manner, any number of couplings along the outer wall of a water tank may be linked by a conduit. In some instances, the junction box 300 may include a single hole 316, and hole 318 may be omitted, or vice versa.

Returning to FIG. 6, after the electrical device is wired (S614), foam insulation may be sprayed (S616). For example, foam insulation may be disposed (e.g., sprayed) into the space between the water tank and the jacket by known methods. After the foam is spayed, the foam may fill the space between the water tank and the jacket and may harden.

After the foam insulation is sprayed (S616), a cavity cover may be fastened (S618). For example, returning to FIGS. 4A-5F, a cavity cover may be detachably fastened to a junction box so as to cover the cavity section of the junction box.

Returning to FIG. 6, after the cavity cover is fastened (S618), method 600 stops (S620).

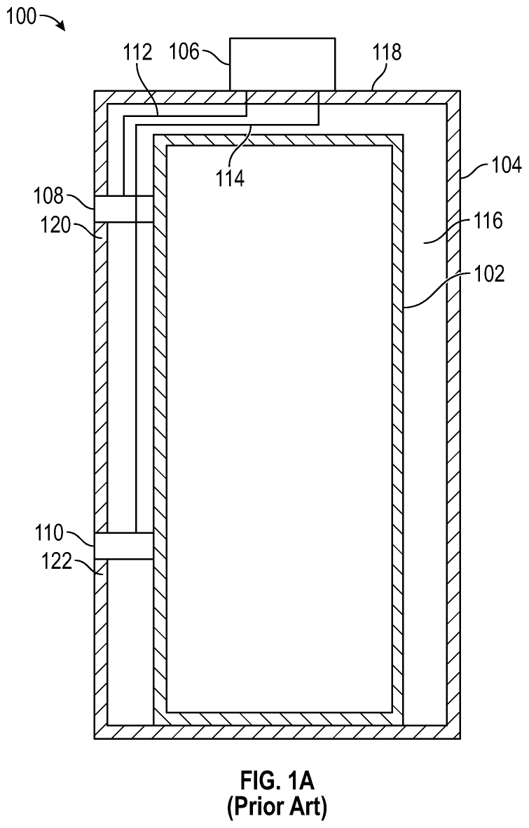

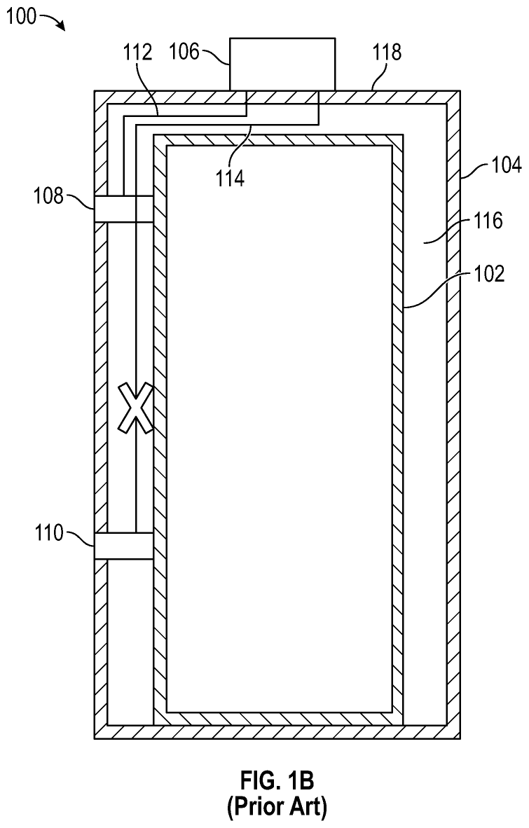

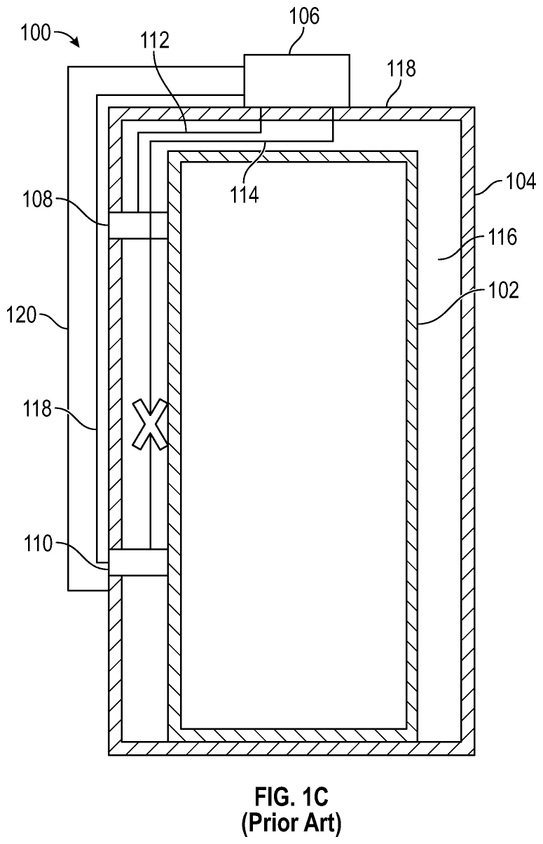

The difference in regard to one or more embodiments of the present disclosure is that in the prior art systems, for example as discussed above with reference to FIGS. 1A-C, the control lines 112 and 114 were encased in the hardened foam insulation. That is, in typical water heaters, the wire harness is disposed within the foam insulation between the jacket and tank, thus not allowing for replacement. If a wire were to break, this situation necessitates installing a harness on the outside of the unit, which the customer finds expensive, problematic, and unfinished. In contrast, in accordance with one or more embodiments of the present disclosure, the conduits are encased in the hardened foam insulation. As such, if any control lines break or corrode, the control lines may be easily replaced via the conduit and junction box system. In this manner, one or more embodiments in accordance with aspects of the present disclosure create an internal conduit and junction box system that includes a pre-made wire harness and allows easy routing of replacement wires.

The Internal conduit/junction box assembly in accordance with aspects of the present disclosure may include multiple conduit sections, multiple electrical junction boxes, and a pre-made wire harness. Additional installation components may include conduit sealing grommets, foam gasketing, and cable ties. Optional color coordinated covers may also be included. The conduit may be any standard or custom tube, made from any suitable material (e.g., metal or plastic), cut to any suitable length, and may be of any diameter (size) required for the wire sizes and quantities.

The junction box may be metal or plastic, and its front and rear surfaces may be contoured to fit between the tank and the jacket. The junction box may include features which allow the attachment of the conduit via a unique loop and separate grommet. In some instances, the junction box may be sealed against the outside of the tank and inside of the jacket with foam gaskets, front and rear, to prevent leakage of insulation foam. The junction box may also include features to attach the cover.

The wire harness may be made from separate, appropriately sized, color-coded wires. The system is designed so wires can be replaced as needed by the service technician.

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A junction box for use with a water heater, a conduit, and a wire, the water heater comprising a water tank, a jacket separated from and concentrically surrounding the water tank, a coupling on the water tank, an electrical device associated with the coupling, and insulation disposed between the water tank and the jacket, the conduit being configured to be disposed between the water tank and the jacket, the wire being configured to be disposed within the conduit and being configured to be connected to the electrical device, the jacket having a jacket opening at the coupling, the junction box comprising:
an insert having a front face and a cavity section,
wherein the front face includes a junction box opening,
wherein the cavity section is accessible via the junction box opening,
wherein the cavity section is configured to fit within the jacket opening, and
wherein the cavity section includes a mounting opening and a conduit opening,
wherein the mounting opening is configured to mount onto the coupling, and wherein the conduit opening is configured to receive the conduit.

2. The junction box of claim 1, further comprising a cavity cover configured to cover the junction box opening and cavity section and to detachably fasten to the insert.

3. The junction box of claim 2, further comprising:
at least one screw,
wherein the front face includes at least one front face screw hole, and
wherein the cavity cover has at least one cavity cover screw hole configured to align with the at least one front face screw hole and to receive the at least one screw so as to fasten the cavity cover to the insert.

4. The junction box of claim 3,
wherein the cavity section includes a latch,
wherein the cavity cover includes a hook configured to hook onto the latch.

5. The junction box of claim 1, wherein the cavity section includes a second conduit opening disposed so as to form an axis between the conduit opening and the second conduit opening and that is normal to each of the conduit opening and the second conduit opening.

6. The junction box of claim 1, wherein the cavity section includes a second conduit opening comprising a first axis that is normal to the conduit opening and a second axis that is normal to the second conduit opening, and wherein the first axis is not parallel with the second axis.

7. A water heater comprising:
a water tank;
a coupling on the water tank;
a jacket separated from and concentrically surrounding the water tank, the jacket having a jacket opening at the coupling;
a conduit disposed between the water tank and the jacket; and
a junction box comprising an insert having a front face and a cavity section,
wherein the front face includes a junction box opening,
wherein the cavity section is accessible via the junction box opening,
wherein the cavity section is configured to fit within the jacket opening, and
wherein the cavity section includes a mounting opening and a conduit opening,
wherein the mounting opening is configured to mount onto the coupling, and wherein the conduit opening is configured to receive the conduit.

8. The water heater of claim 7, further comprising a cavity cover configured to cover the junction box opening and cavity section and to detachably fasten to the insert.

9. The water heater of claim 8, further comprising:
at least one screw,
wherein the front face includes at least one front face screw hole, and
wherein the cavity cover has at least one cavity cover screw hole configured to align with the at least one front face screw hole and to receive the at least one screw so as to fasten the cavity cover to the insert.

10. The water heater of claim 9,
wherein the cavity section includes a latch,
wherein the cavity cover includes a hook configured to hook onto the latch.

11. The water heater of claim 7, wherein the cavity section includes a second conduit opening disposed so as to form an axis that is normal to each of the conduit opening and the second conduit opening.

12. The water heater of claim 7, wherein the cavity section includes a second conduit opening disposed such that a first axis is normal to the conduit opening, a second axis is normal to the second conduit opening, and the first axis is not parallel with the second axis.

13. The water heater of claim 9, further comprising:
a second coupling on the water tank;
a second junction box comprising a second insert having a second front face and a second cavity section, and
a second conduit disposed between the water tank and the jacket,
wherein the second front face includes a second junction box opening,
wherein the jacket has a second jacket opening at the second coupling,
wherein the second cavity section is accessible via the second junction box opening,
wherein the second cavity section is configured to fit within the second jacket opening,
wherein the second cavity section includes a second mounting opening and a second conduit opening, the second mounting opening being configured to mount onto the second coupling, the second conduit opening being configured to receive the second conduit, and
wherein the cavity section further includes a third conduit opening configured to receive the second conduit.

14. The junction box of claim 13, further comprising a second cavity cover configured to cover the second jacket opening and the second cavity section and to detachably fasten to the second insert.

15. A method of making a water heater, the method comprising:
mounting a junction box to a coupling of a water tank, the junction box including an insert having a curved front face and a cavity section;
disposing a conduit into the cavity section; and
concentrically surrounding, with a jacket and by a radial distance, the water tank and conduit.

16. The method of claim 15,
wherein the jacket has a jacket opening at the coupling,
wherein the curved front face has a junction box opening,
wherein the cavity section is accessible via the junction box opening,
wherein the curved front face has a front face curvature configured to match a curvature of the jacket,
wherein the cavity section is configured to fit within the jacket opening and have a cavity curvature configured to match a curvature of the water tank, and
wherein the cavity section includes a mounting opening and a conduit opening, the mounting opening being configured to mount onto the coupling, the conduit opening being configured to receive the conduit.

17. The method of claim 15, further comprising detachably fastening a cavity cover to the insert.

18. The method of claim 17, further comprising:
at least one screw,
wherein the front face includes at least one front face screw hole, and
wherein the cavity cover has at least one cavity cover screw hole configured to align with the at least one front face screw hole and to receive the at least one screw so as to fasten the cavity cover to the insert.

19. The method of claim 18,
wherein the cavity section includes a latch,
wherein the cavity cover includes a hook configured to hook onto the latch.

20. The method of claim 15, wherein the cavity section includes a second conduit opening disposed so as to form an axis between the conduit opening and the second conduit opening and that is normal to each of the conduit opening and the second conduit opening.
